(19) United States
(12) Patent Application Publication
(10) Pub. No.: US 2022/0394314 A1
(43) Pub. Date: Dec. 8, 2022

(54) SYSTEM AND METHOD FOR IMPROVED MEDIA ACQUISITION RESPONSE

(71) Applicant: ARRIS ENTERPRISES LLC, Suwanee, GA (US)

(72) Inventor: Yuvaraj Nagarathinam, Bangalore (IN)

(73) Assignee: ARRIS ENTERPRISES LLC, Suwanee, GA (US)

(21) Appl. No.: 17/830,068

(22) Filed: Jun. 1, 2022

(30) Foreign Application Priority Data
Jun. 3, 2021 (IN) 202121024731

(51) Int. Cl. H04N 21/239; H04N 21/218; H04L 65/611

(52) U.S. Cl. CPC H04N 21/2393; H04N 21/218; H04L 65/611

(57) ABSTRACT

A system and method providing a video content acquisition system adapted to determine content acquisition delays as a function of the source of the content. In particular, the system and method minimize delays experienced by users requesting video content via a client device. This is accomplished by tailoring the acquisition delay time associated with a particular request for content based upon the source of the signal from which the requested content is to be obtained (broadcast, satellite, cable, internet, etc.), as well as the type of signal requested and/or rate at which the source signal provides content (symbols/sec, bits/second, etc.). This minimizes the amount of time a user may mistakenly perceive a client device to be unresponsive or incapable of providing the requested video content.

### CROSS-REFERENCE TO RELATED APPLICATION

This application claims the benefit of Provisional Patent Application No. 202121024731, filed Jun. 3, 2021 with the Office of the Controller General of Patents, Designs and Trade Marks of India, which is incorporated by reference herein in its entirety.

### BACKGROUND OF THE INVENTION

There is a continuing shift in the manner in which digital video content is accessed and consumed by residential viewers. More and more of this content is being consumed via devices and interfaces adapted to receive video content encoded and packetized in accordance with Internet Protocol (“IP”) standards promulgated by the Internet Engineering Task Force (“IETF”). This type of video content delivery is referred to as IPTV.

Devices capable of receiving, storing or displaying IPTV content need not include a tuner typically associated with acquiring and locking onto a modulated video transmission signals, such as those associated with broadcast, cable or satellite video systems. Such IPTV client devices can include dedicated appliances, such as set-top boxes, media gateways and digital televisions, as well as more generic or multifunction appliances such smartphones, tablets and computers.

The process by which an IPTV client acquires desired IP video content involves the client sending a request to a content server via an IP network. This server may include an interface to one or more IP video sources (streaming services, digital storage devices, etc.), as well as one or more tuners capable of locking onto a specific video programming within a modulated broadband transmission signal (broadcast, cable and/or satellite). In response to the received request, the IP video server links the requesting client device with the proper video source. This linking can be as simple as providing a conduit to the appropriate IP video stream or repository, or may require the utilization of a tuner to acquire, lock on, demodulate and properly IP packetize the desired video from a transmitted video signal.

The time required to tune, lock on, demodulate and packetize the requested video content can introduce a noticeable delay between the time a user initiates the request upon the IP client device and the time the requested video is available for viewing. The specific amount of delay can vary based upon the particular type and format of the signal delivering the requested video content. For example, a system acquiring content from a digital video broadcast satellite signal employing ½ code rate and having a symbol rate of approximately two-million symbols/second (DVB-S ½ 2MSy/s) would take approximately five seconds to acquire the stream of video content. If the content were being acquired from a DVB-S ⅘ 20MSy/s signal, the acquisition time would be approximately half a second. Present IP client devices are blind to the acquisition characteristics of the particular broadcast or streaming content received via a given content server. Typically, such systems default to a fixed maximum acquisition delay time of approximately ten seconds regardless of the actual acquisition time required to obtain requested video content.

During this fixed ten-second delay the user may receive no visual feedback from the IP client device, or be provided a default messages such as “Acquisition Pending” or “Not Locked”. While such delays are typically not in excess of ten seconds, they can be perceived as annoying by users. This fixed delay can prove particularly annoying to users when the desired video source should introduce a minimal delay, such as an Internet service which streams packetized IP video. Regardless of the content source, the lack of a response or a continued message indicative of an inability to acquire or lock onto the requested content can lead users to conclude that the issued request was ineffective or has failed. Users may react by issuing multiple, erroneous commands attempting to provoke a response from the system. Users may even become so frustrated during the delay that they simply terminate the use of the client device, believing that the requested content is simply unavailable. None of these scenarios result in a desirable user experience.

Consequently, there exists a need for a system and method providing a user experience wherein the acquisition delay imposed upon a user utilizing an IP client device is determined by one or more of the source, type and rate of the requested content signal (IP or broadcast). This would minimize unnecessary delays in client device response, thereby resulting in an improved user experience.

### BRIEF SUMMARY OF THE INVENTION

A system and method providing a video content acquisition system adapted to determine content acquisition delays as a function of the source of the content. In particular, the system and method minimize delays experienced by users requesting video content via a client device. This is accomplished by tailoring the acquisition delay time associated with a particular request for content based upon the source of the signal from which the requested content is to be obtained (broadcast, satellite, cable, internet, etc.), as well as the type of signal requested and/or rate at which the source signal provides content (symbols/sec, bits/second, etc.). This minimizes the amount of time a user may mistakenly perceive a client device to be unresponsive or incapable of providing the requested video content.

### BRIEF DESCRIPTION OF THE DRAWINGS

The aspects, and advantages of the present invention will become better understood with regard to the following description, appended claims, and accompanying drawings in which:

FIG. 1 is a functional block diagram of a system supporting the determination of content acquisition delays as a function of the source and/or type of the requested content.

FIG. 2 is a table representative of information indicative of the source, signal type and signal rate of content that can be accessed via the system of FIG. 1.

FIG. 3 is a flow diagram of a first process supported by the system of FIG. 1.

### DETAILED DESCRIPTION

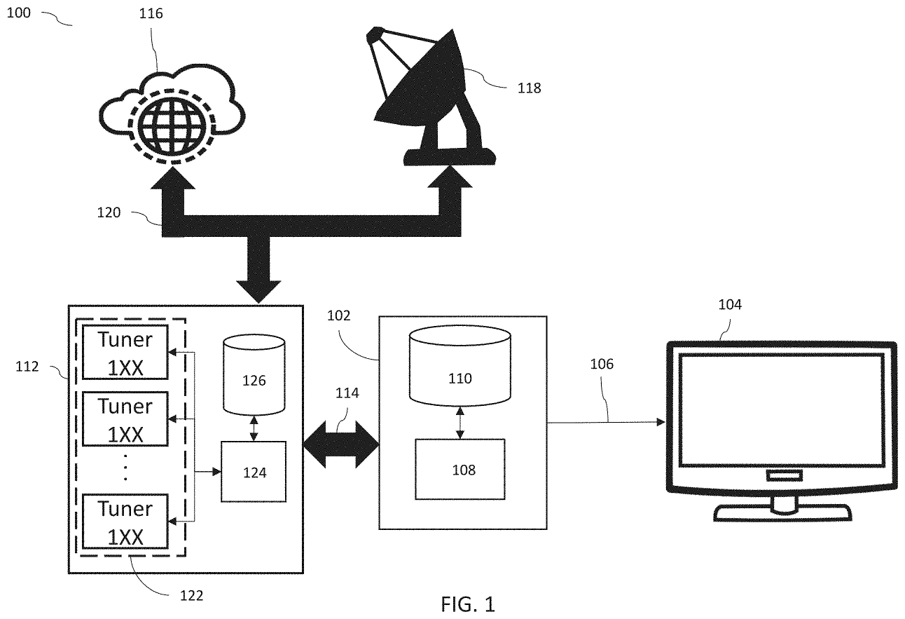

FIG. 1 provides a functional block diagram of system 100 which supports a video content acquisition system adapted to determine content acquisition delays as a function of the source and/or type of the content. As shown, the system includes client device 102 which serves to provide video content to monitor 104 via high-definition media interface 106. Client device 102 is shown to include controller 106 and memory 108. Client device 102 is also shown to be connected to media server 112 via local network 114. Media server 112 can be any appliance adapted to receive video content, including a set-top or a similar media routing and acquisition system. Media server 112 is shown to be linked to Internet video streaming service 116 and satellite downlink 118 via broadband network 120. Multiple video tuners (122), controller 124 and memory 126 are also shown to be components of media server 112.

Media server 112 is adapted to periodically provide client device 102 with information indicative of the content available via media server 112 from Internet video streaming service 116 and satellite downlink 118. This information would be provided to media server 112 from each content source via broadband network 120 and stored within memory 126. The service providers associated with satellite downlink 118 and/or streaming service 116 could be granted access to media server 112 for purposes of storing the requisite information. Such information could also be provided, in whole or in part, by a user of client device 102 via one or more user interfaces (not pictured). Such user interfaces (keyboards, smart devices, digital assistants, remote controls, etc.) could be integral to client device 102, or linked to it either by wired or wireless means.

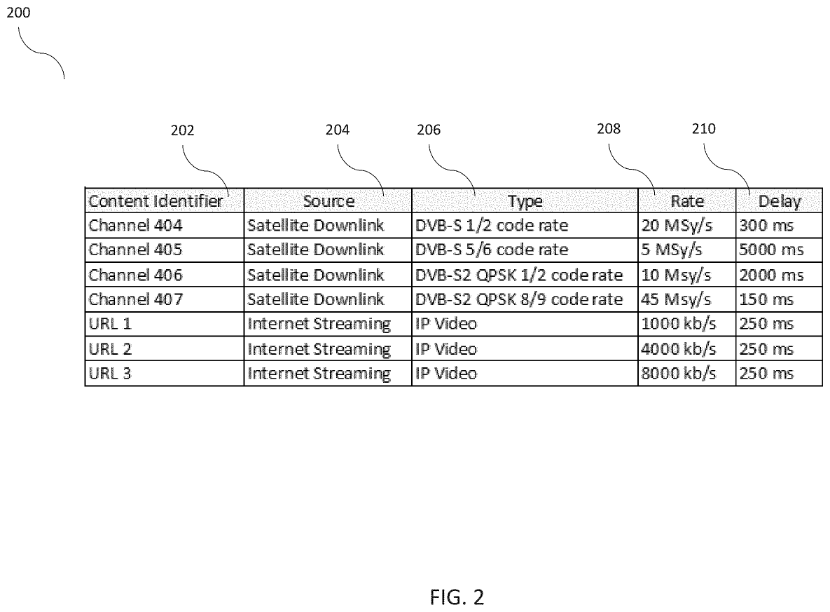

FIG. 2 provides a table (200) representative of the information stored in memory 126. As shown, the stored information includes a content identifier (202) which provides the channel that must be tuned to obtain the content or the URL for accessing streaming IPTV content. The stored information also includes information indicative of the source (204) of the identified content, the type of encoding (206) utilized for the identified content, the symbol or data rate (208) of the identified content, and the typical acquisition delay (210) associated with the identified content. The provision of this stored information to client device 102 by media server 112 could be accomplished by downloading the information from memory 126 to client device memory 110, or by the provision of a Universal Record Locator (“URL”) to client device 102 by media server 112, wherein the provided URL is associated with an Extensible Markup Language (“XML”) file. The XML file could then be accessed by processor 108 and the information contained therein stored in memory 110.

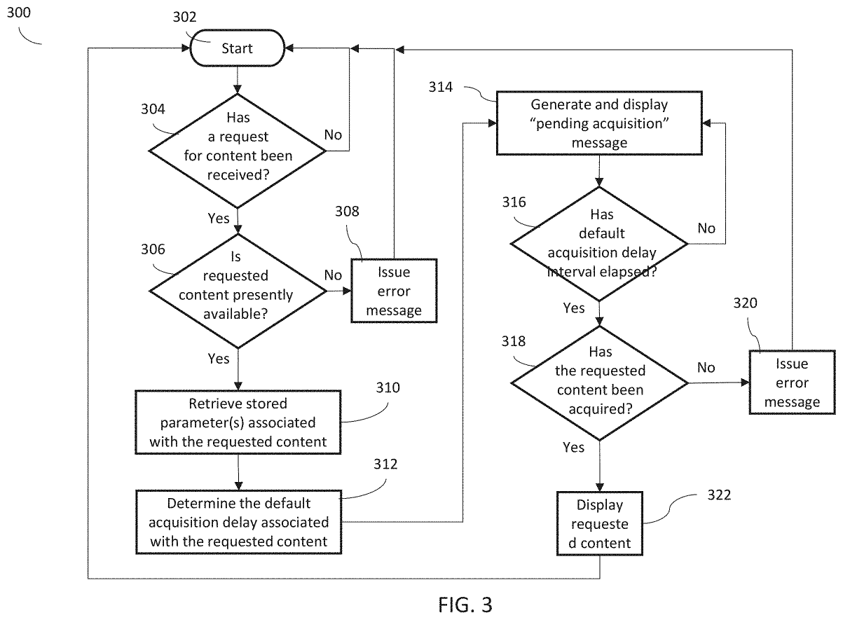

FIG. 3 provides a flow diagram of a preferred process (300) utilizing the system of FIG. 1. The process begins with processor 108 within client device 112 determining if a user has issued a request for the acquisition of particular content from Internet video streaming service 116 and/or satellite downlink 118 (see steps 302 and 304). Such requests would be typically be initiated in response to one or more user commands issued from the aforementioned user interface linked to client device 102. If no such request is evident, the process loops back to step 302. However, if it is determined that a request for particular content has been received, the processor 108 queries memory 110 to determine if the stored information (see FIG. 2) indicates that the requested content is available (step 306). This determination would likely be made based upon the specific channel or URL requested by a user, but could also be made on the basis of other information, such as content title, which could be stored within memory 110 and associated with parameters similar to those shown in of FIG. 2. If information associated with the requested content isn't stored within memory 110, the content is deemed unavailable and the process continues with the generation of an error message by client device 102 (step 308), and then loops back to step 302. Such an error message could be communicated to a user via monitor 104, or via a user interface linked to client device 102.

However, if processor 108 determines that information associated with the requested content is stored within memory 110, the process continues with step 310 and the retrieval from memory 110 of one or more parameters associated with the requested content. From this retrieved information, processor 108 determines the default acquisition time associated with the requested content. As shown in FIG. 2, this default acquisition time is among the parameters stored within memory 100, and the value for such is simply retrieved from memory 110 by processor 108. Processor 108 then generates a message indicating that the acquisition of the requested content is pending. This message is provided to the user via monitor 104 for an interval equal to the retrieved default acquisition time (steps 314 and 316).

When the default acquisition time interval has elapsed, the process continues with step 318 and processor 108 determines if the requested video content is available from media server 112. If not, an error message informing the user that the request could not be fulfilled is issued (step 320). This message could be provided via monitor 104 or via an alternate user interface. Following the display of this error message the process loops back to steps 302 and 304, and awaits a new user request. However, if the requested content is available from media server 102, the content is accepted by client device 102 and displayed upon monitor 104 (step 322). The process continues with steps 302 and 304, and awaits a new user request.

Although the invention herein has been described with reference to a particular embodiment, it is to be understood that this embodiment is merely illustrative of the principles and applications of the present invention. Other embodiments and variations could be implemented without departing from the spirit and scope of the present invention as defined by the appended claims. For example, the invention could be applied in environments where the content providers including multi-service operators providing content via cable or optical networks, or those providing content via terrestrial broadcast. The monitor associated with the invention could be a digital television, a computer monitor, a smart device, a digital assistant or a tablet. Similarly, the invention could be implemented in environments that include multiple client devices connected to a single media server. Each of these client devices capable of independently requesting content from the media server. Although invention has been described as directly retrieving the default acquisition time from a memory within a media server, embodiments of the invention include systems wherein the default acquisition time is calculated based upon one or more other content-related parameters retrieved from a media server, such as the content identifier, content source, type of content encoding, the content rate, etc. Furthermore, a media gateway, a smartphone, a tablet, a digital television, a digital assistant or a computer could all be utilized as a client device. It will also be understood that the various connections depicted as wired in the above embodiments could also be supported by wireless connections without departing from the scope of the invention. The processes described herein could be performed by a single or multiple multi-processor system, co-located with the user and/or device(s) being controlled, or remotely based in whole or in part. The memory or memories supporting the functionality of the invention storage of the data can be a disk, a solid-state drive, cloud-based storage (in whole or in part), or any other means with sufficient capacity.

1. A system for acquiring digital content comprising:
at least one media server adapted to obtain digital content from at least one content provider in response to received requests;
at least one memory storing information indicative of at least one parameter associated with the digital content from the at least one content provider; and
at least one controller, adapted to:
receive at least one user request identifying a particular digital content;
retrieve from the at least one memory information indicative of at least one parameter associated with the particular digital content; and
determine, based, at least in part, upon the retrieved information, a default time associated with the acquisition of the particular digital content by the at least one media server.

2. The system of claim 1 where in the at least one content provider comprises at least one of the following:
a multi-service operator;
a cable provider;
an optical system provider;
an Internet streaming provider;
a terrestrial broadcast provider; and
a satellite provider.

3. The system of claim 1 wherein the information indicative of at least one parameter associated with the digital content from the at least one content provider comprises at least one of the following:
a content provider identifier;
a content title;
an encoding type;
a content rate; and
a default acquisition delay interval.

4. The system of claim 1 wherein the at least one memory comprises at least one of the following:
a disc drive;
a solid-state drive; and
a cloud-based storage system.

5. The system of claim 1 wherein the at least one memory is integral to the at least one media server.

6. The system of claim 5 wherein the controller comprises a client device.

7. The system of claim 6 wherein the at least one controller is further adapted to:
retrieve the information indicative of at least one parameter associated with the digital content from the at least one memory;
and store the retrieved information in a memory associated with the client device.

8. The system of claim 6 wherein the client device comprises at least one of the following:
a media gateway;
a smartphone;
a tablet;
a digital television;
a digital assistant; and
a computer monitor.

9. The system of claim 1 wherein the at least one controller is further adapted to:
generate a message indicative of a pending acquisition of the particular digital content by the at least one media server; and
display the generated message upon a device for an interval substantially equal to the determined default time.

10. The system of claim 9 wherein the device displaying the generated message comprises at least one of the following:
a smartphone;
a tablet;
a digital television;
a digital assistant; and
a computer monitor.

11. A method for acquiring digital content, in a system comprising:
at least one media server adapted to obtain digital content from at least one content provider in response to received requests; and
at least one memory storing information indicative of at least one parameter associated with the digital content from the at least one content provider;
the method comprising the steps of:
receiving at least one user request identifying a particular digital content;
retrieving from the at least one memory information indicative of at least one parameter associated with the particular digital content; and
determining, based, at least in part, upon the retrieved information, a default time associated with the acquisition of the particular digital content by the at least one media server.

12. The method of claim 11 where in the at least one content provider comprises at least one of the following:
a multi-service operator;
a cable provider;
an optical system provider;
an Internet streaming provider;
a terrestrial broadcast provider; and
a satellite provider.

13. The method of claim 11 wherein the information indicative of at least one parameter associated with the digital content from the at least one content provider comprises at least one of the following:
a content provider identifier;
a content title;
an encoding type;
a content rate; and
a default acquisition delay interval.

14. The method of claim 11 wherein the at least one memory comprises at least one of the following:
a disc drive;
a solid-state drive; and
a cloud-based storage system.

15. The method of claim 11 wherein the at least one memory is integral to the at least one media server.

16. The method of claim 15 wherein the system further comprises a client device.

17. The method of claim 16 further comprising the steps of:
retrieving the information indicative of at least one parameter associated with the digital content from the at least one memory;
and storing the retrieved information in a memory associated with the client device.

18. The method of claim 16 wherein the client device comprises at least one of the following:
a media gateway;
a smartphone;
a tablet;
a digital television;
a digital assistant; and
a computer monitor.

19. The method of claim 11 wherein the system further comprises at least one display, and the method further comprises the steps of:
generating a message indicative of a pending acquisition of the particular digital content by the at least one media server; and
displaying the generated message upon the at least one display for an interval substantially equal to the determined default time.

20. The method of claim 19 wherein the device displaying the generated message comprises at least one of the following:
a smartphone;
a tablet;
a digital television;
a digital assistant; and
a computer monitor.
